(19) United States
(12) Patent Application Publication
(10) Pub. No.: US 2021/0237308 A1
(43) Pub. Date: Aug. 5, 2021

(54) ADDITIVE MANUFACTURING OF HOLLOW OR PARTIALLY HOLLOW ROLLING ELEMENTS

(71) Applicant: Schaeffler Technologies AG & Co. KG, Herzogenaurach (DE)

(72) Inventors: Perry Hollen, Fort Mill, SC (US); Jean-Francois Masbou, Fort Mill, SC (US)

(73) Assignee: Schaeffler Technologies AG & Co. KG, Herzogenaurach (DE)

(21) Appl. No.: 17/158,398

(22) Filed: Jan. 26, 2021

Related U.S. Application Data
(60) Provisional application No. 62/969,962, filed on Feb. 4, 2020.

(51) Int. Cl. B28B 1/00; B33Y 10/00; B33Y 80/00; B28B 11/08; B33Y 40/20

(52) U.S. Cl. CPC B28B 1/001; B33Y 10/00; B33Y 40/20; B28B 11/08; B33Y 80/00

(57) ABSTRACT

A hollow bearing rolling element or a rolling element with a lattice internal structure provides several advantages over a solid bearing. It is lighter than a solid bearing. Less material is required and sintering times are reduced because bonding material can flow easily to near the surface. The blank is formed using an additive manufacturing processes which offers better uniformity than a conventional two die process, enabling production of blanks much closer to finished size. They also eliminate the “Saturn Ring” associated with the conventional process. This translates into reduced grinding allowances and shorter processing time reducing both material and finishing operations costs. These processes also enable the production of hollow elements and partially hollow elements further reducing material costs, addressing the problems inherent to core material removal and reducing sintering time. The advantages offered by the additive manufacturing are especially beneficial for large products made in small batches.

### CROSS-REFERENCE TO RELATED APPLICATIONS

This application claims priority to 62/969,962 filed Feb. 4, 2020, the entire disclosure of which is incorporated by reference herein.

### TECHNICAL FIELD

The disclosure concerns a method of manufacturing bearing rolling elements. More particularly, the disclosure pertains to a method employing additive manufacturing to fabricate rolling bearings that are hollow or which have a lattice inner core.

### BACKGROUND

Bearings reduce the friction between components which are intended to move relative to one another, especially as force is transmitted from one of the components to the other. In rolling element bearings, a raceway is formed in each of the two components and a set of elements are contained within the raceways, separating the components. The contact between the elements and the raceways is predominantly rolling contact as opposed to sliding contact, thereby dramatically reducing the resistance to relative motion. In some applications, the rolling elements may be spaced relative to one another by a cage. Rolling elements may be balls, cylindrical rollers, tapered rollers, or spherical rollers.

Rolling elements may be made of metal, ceramics, or other materials depending on the application. FIG. 1 illustrates a conventional process for molding a blank for a rolling element. The blank is formed is a two-piece die 10 and 12. A die gap 14, between the upper and lower die upon compaction, is around 100 microns but will vary both in width and thickness according size of the ball, tooling conditions and other variables. The quality of the tooling and compaction process will determine the condition of the formed ball and the necessary processing in subsequent steps to correct any imperfections. Once the ball has been formed in the die system, the aforementioned gap will leave behind a thin strip of extra material around the equator of the ball. This raised material is commonly referred to as the “Saturn Ring” and must be removed in the following processing steps. Furthermore, any imperfections in the shape of the dies and the balance of pressures exerted on the ball during compaction, will result in a ball that will not be considered round. This deviation to the form and along with the other effects during the sintering process, such as deformation and shrinkage, will all need to be considered in allowing more material to be removed, resulting in a perfect spherical shape when completed. To compensate these distortions, large amounts of “grind” stocks are added to enable the creation of a true sphere through a series of processing operations. This grind stock allowance typically varies from 0.8 mm for a 10 mm diameter ball to as much as 1.9 mm for a 60 mm diameter ball.

In some applications, ceramic rolling elements offer advantages over their steel counterparts. The density, lower than steel for most ceramics (Silicon Nitride Si₃N₄ in particular), makes a very strong and light part allowing for good heat dissipation. It also offers electrical insulation properties valuable in some applications. The lower weight is also beneficial in high-speed applications by reducing centrifugal forces and improving system efficiency.

The main issues of the current solid ceramic rolling elements are the costs of the material and the length of time required to produce such a product. The typical manufacturing process includes making a blank by mixing a ceramic powder with bonding agents, then pressing the mixture into a die. The resulting blank can be either machined, prior to sintering, or sintered directly followed by several processing steps to reach final dimensions and surface finish. The bonding material is required in order for the ceramic particles to hold their shape after removal from the die. Although the bonding material is required to make the rolling element, it must be removed during the hardening process to produce a pure ceramic product with the highest possible levels of particulate density. Extreme heat is required to burn off the bonding materials during the ceramic hardening. Larger rolling elements require longer processing times with more potential for distortion from shrinkage.

The downside of the above-described process is high cost due to expensive material (up to 70% of total cost) and multiple, very long processing steps (typically between 150 and 500 hours). This high cost limits the applications of these products to niche fields where heat or speed are critical factors. Furthermore, as blanks are produced in a die, tooling cost and delivery are important factors dramatically increasing the cost-effectiveness for low-volume applications.

### SUMMARY

A ceramic rolling element manufacturing process fabricating a blank using an additive manufacturing process, sintering the blank, and grinding the blank. The blank is formed from a mixture of a ceramic powder and a bonding agent. The sintering removes the bonding agent and hardens the ceramic powder. The grinding creates a final rolling element shape. The blank may have an outer shell surrounding a core with at least one intentional void. The core may be hollow or may form a lattice of ceramic powder and bonding agent. The shell may have a spherical outer surface.

### BRIEF DESCRIPTION OF THE DRAWINGS

FIG. 1 is a schematic illustration of a conventional blank forming process.

FIG. 2 is a cut-away view of a hollow ball rolling element.

FIG. 3 is a cut-away view of a partially hollow ball rolling element with a lattice core.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

Use of hollow or partially hollow rolling elements offers advantages in many applications regardless of material and geometric configurations.

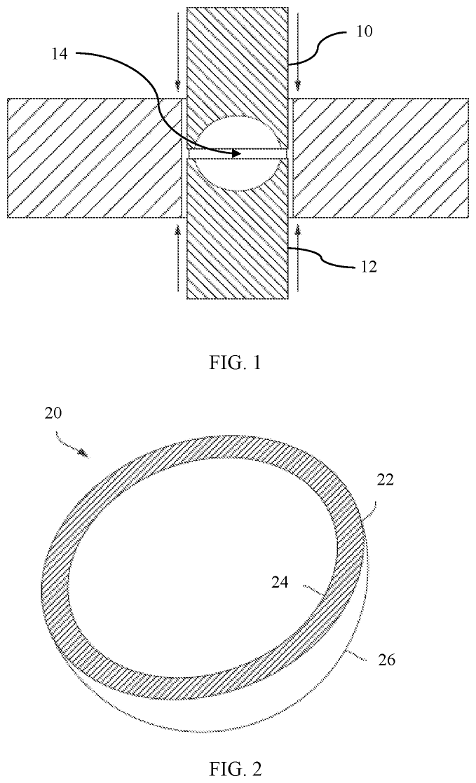

FIG. 2 is a cut-away view illustrating a hollow ball rolling element 20. Rolling elements other than balls may also be hollow. The ball includes a shell 22 with an inner spherical surface 24 and an outer spherical surface 26. The shell must be sufficiently thick to carry the design load. Hollow ceramic rolling elements are particularly advantageous. For a given rolling element diameter, a hollow rolling element uses substantially less material, reducing both cost and mass. Furthermore, evacuating the bonding materials from the shell requires substantially less time than removing them from the core of a solid element.

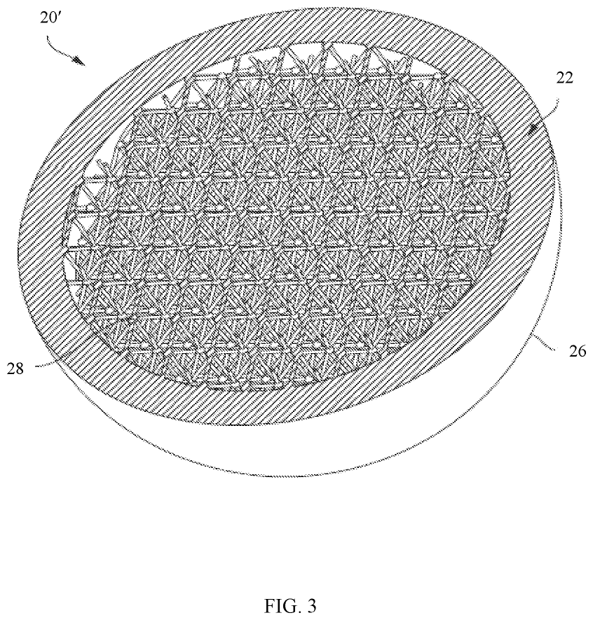

FIG. 3 is a cut-away view illustrating a partially hollow ball rolling element 20′ with a skeletal core 28. The skeletal framework provides extra strength, increasing the load capacity or decreasing the required shell thickness for a given design load. The open space in the lattice permits the bonding material from the lattice material to move easily to the inner surface of the shell during the sintering process, such that sintering times are substantially reduced relative to a solid.

Conventional molding processes are unsuitable for fabricating the blanks for the balls of FIGS. 1 and 2. However, additive manufacturing processes (sometimes called 3D printing) are capable of producing these blanks. Several ceramic additive manufacturing processes are available. Nanoparticle jetting (NPJ) utilizes a 3-axis coordinate system to project a slurry which is hardened through a focalized light source. While slow (production time for a complete 2 inches ball is around 70 hours), the worktable is relatively large allowing the production of twelve 2 inch balls at the same time. The balls must then be cleansed in a water solution and later sintered, complete hardening, which results in a shrinkage between 15 and 20%.

Another process is Lithography-based Ceramic Manufacturing (LCM). This process consists of a slurry table and a build plate moving vertically from the slurry table, building the product upward (or downward depending on the machine and process design). A light is used at the opposite end of the work table to solidify the slurry. The process current capability is around 1.5 mm/hour for a Silicone Nitride ball. Two 2 inch balls can be achieved in around 18 hours. Additional working heads can be coupled to improve production rate.

These 3D printing processes offer better uniformity than the two die process, enabling production of blanks much closer to finished size. They also enable elimination of the “Saturn Ring” altogether. In turn, this translates into reduced grinding allowances and shorter processing time reducing both material and finishing operations costs. These processes also enable the production of hollow elements and partially hollow elements further reducing material costs, addressing the problems inherent to core material removal and reducing sintering time.

The advantages offered by the additive manufacturing are especially beneficial for large products made in small batches. The additive manufacturing processes offer significant improvements in product performance while lowering the cost and as the production process allows the production of a single ball economically (as opposed to a batch), expenses tied to immobilization of capital are also reduced.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A ceramic rolling element manufacturing process comprising:
fabricating a blank using an additive manufacturing process, the blank formed from a mixture of a ceramic powder and a bonding agent;
sintering the blank to remove the bonding agent and harden the ceramic powder; and
grinding the blank to create a final rolling element shape.

2. The process of claim 1 wherein the blank comprises an outer shell surrounding a core with at least one intentional void.

3. The process of claim 2 wherein the core contains no ceramic powder and bonding agent.

4. The process of claim 2 wherein the core is a lattice of ceramic powder and bonding agent.

5. The rolling element of claim 1 wherein the shell has a spherical outer surface.
